(19) United States
(12) Patent Application Publication
(10) Pub. No.: US 2008/0172238 A1
(43) Pub. Date: Jul. 17, 2008

(54) ELECTRONIC SYSTEM WITH RUN-TIME INFORMATION

(76) Inventor: Yosuke Muraki, Campbell, CA (US)

Correspondence Address: LAW OFFICES OF MIKIO ISHIMARU, 333 W. EL CAMINO REAL, SUITE 330, SUNNYVALE, CA, 94087, US

(21) Appl. No.: 11/623,054

(22) Filed: Jan. 12, 2007

(51) Int. Cl. G06Q 10/00

(52) U.S. Cl. 705/1

(57) ABSTRACT

An electronic system is provided including providing a run-time system having a timing generator, an information generator, and a non-volatile storage; retrieving a system information from the non-volatile storage; and enabling the run-time system including generating an information timer, updating the system information based on the information timer for generating an updated system information, and storing the updated system information in the non-volatile storage.

### TECHNICAL FIELD

The present invention relates generally to electronic system and more particularly to computer system.

### BACKGROUND ART

Modern consumer electronics, such as game consoles, notebook computers, smart phones, personal digital assistants, and location based services devices, as well as enterprise class electronics, such as servers, storage arrays, and routers, have integrated circuits and other components that may degrade over time and usage.

For example, a light emitting diode used for game displays or status may loose luminance or simply fail to emit light after a time period of use. Another example, a non-volatile memory may fail to store information as the number of writes reached a predetermined endurance cycle. Yet another example, a game terminal may function for a predetermined number of “frantic presses” on the action keys.

Modern electronics like many other consumed products are sold as new equipment and resold as used equipment. A potential valuation criterion is the age of the used equipment. However, the difference between the manufacturing date and the current date is not an adequate measure to determine used equipment valuation.

In general, buyers may determine a valuation or a price of a used product with the elapsed days from the manufactured date. However, different users run products for different hours. In other words, the elapsed days of the product are not always proportional to the total run time of the product. Also, vendors need to know if a part of the product is potentially out of order or just exhausted because of over use. Such information is very important for vendors to improve the manufacture process.

Thus, a need still remains for an electronic system with a run-time system for providing reliable run-time information for the electronic systems. In view of the ever-increasing need to save costs and improve efficiencies, it is more and more critical that answers be found to these problems.

Solutions to these problems have been long sought but prior developments have not taught or suggested any solutions and, thus, solutions to these problems have long eluded those skilled in the art.

### DISCLOSURE OF THE INVENTION

The present invention provides an electronic system including providing a run-time system having a timing generator, an information generator, and a non-volatile storage; retrieving a system information from the non-volatile storage; and enabling the run-time system including generating an information timer, updating the system information based on the information timer for generating an updated system information, and storing the updated system information in the non-volatile storage.

Certain embodiments of the invention have other aspects in addition to or in place of those mentioned or obvious from the above. The aspects will become apparent to those skilled in the art from a reading of the following detailed description when taken with reference to the accompanying drawings.

### BRIEF DESCRIPTION OF THE DRAWINGS

FIGS. 1A, 1B, and 1C are schematic views of examples of electronics systems in which various aspects of the present invention may be implemented;

FIG. 2 is a block diagram of a run-time system in an embodiment of the present invention;

FIG. 3 is a schematic view of a run-time system in an embodiment of the present invention;

FIG. 4 is a schematic view of a run-time system in an alternative embodiment of the present invention;

FIG. 5 is a schematic view of a run-time system in another alternative embodiment of the present invention;

FIG. 6 is a flow chart of a run-time system for operation the run-time system of FIG. 3 in an embodiment of the present invention;

FIG. 7 is a flow chart of a run-time system for operation the run-time system of FIG. 3 in an alternative embodiment of the present invention; and

FIG. 8 is a flow chart of an electronic system for operation of the electronic system in an embodiment of the present invention.

### BEST MODE FOR CARRYING OUT THE INVENTION

The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail. Likewise, the drawings showing embodiments of the system are semi-diagrammatic and not to scale and, particularly, some of the dimensions are for the clarity of presentation and are shown greatly exaggerated in the drawing FIGs. In addition, where multiple embodiments are disclosed and described having some features in common, for clarity and ease of illustration, description, and comprehension thereof, similar and like features one to another will ordinarily be described with like reference numerals.

For expository purposes, the term “horizontal” as used herein is defined as a plane parallel to the plane or surface of the integrated circuit, regardless of its orientation. The term “vertical” refers to a direction perpendicular to the horizontal as just defined. Terms, such as “above”, “below”, “bottom”, “top”, “side” (as in “sidewall”), “higher”, “lower”, “upper”, “over”, and “under”, are defined with respect to the horizontal plane. The term “on” means there is direct contact among elements. The term “system” as used herein means and refers to the method and to the apparatus of the present invention in accordance with the context in which the term is used.

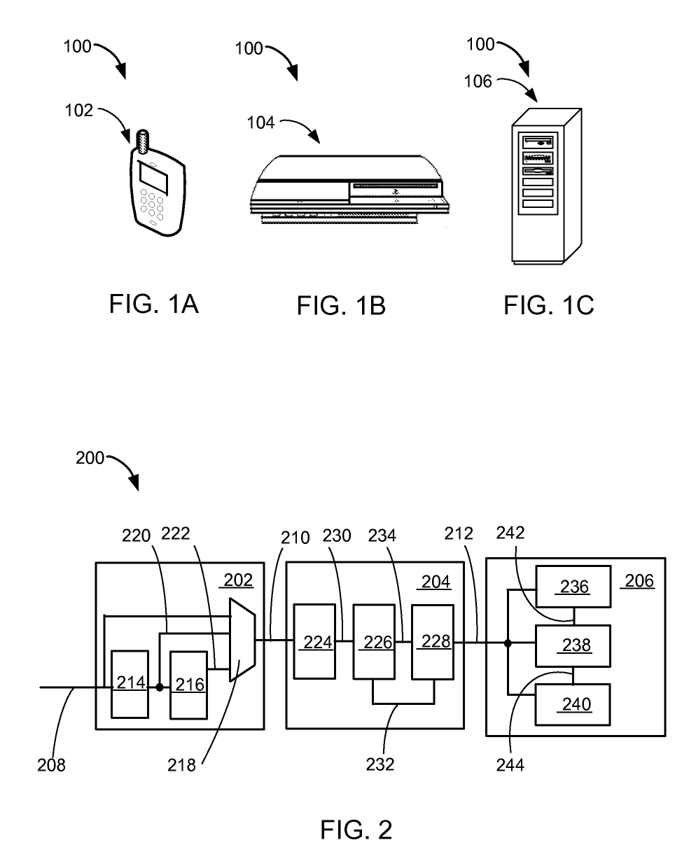

Referring now to FIGS. 1A, 1B, and 1C, therein are shown schematic views of examples of electronics systems 100 in which various aspects of the present invention may be implemented. A smart phone 102, a game console 104, and a computer system 106 are examples of the electronic systems 100 using the present invention. The electronic systems 100 may be any system that performs any function for the creation, transportation, storage, and consumption of information.

For example, the smart phone 102 may create information by transmitting voice to the computer system 106 or consume information by playing a game with the game console 104. The smart phone 102, the game console 104, and the computer system 106 may be used to store the information. Other electronic systems (not shown) may be used to transport information amongst the smart phone 102, the game console 104, and the computer system 106.

Referring now to FIG. 2, therein is shown a block diagram of a run-time system 200 in an embodiment of the present invention. The run-time system 200 may be included in the electronic systems 100 of FIG. 1 for providing information, such as run-time or power-on time by a customer or in the factory. The block diagram depicts a timing generator 202, an information generator 204, and a non-volatile storage 206.

The timing generator 202 may receive a reference timer 208, such as a reference clock, and outputs an information timer 210, such as a divided clock or a signal pulse. The information generator 204 receives the information timer 210 from the timing generator 202 and outputs system information 212, such as run-time or power-on time by a customer or in the factory. The non-volatile storage 206 receives the system information 212 from the information generator 204 for storage in non-volatile media.

The timing generator 202 includes a clock generator 214, a clock divider 216, and a clock multiplexer 218. The reference timer 208 may feed the clock generator 214. The clock generator 214 may output a first clock 220 based on the reference timer 208. The timing generator 202 may include other modules (not shown) that may operate with the first clock 220. The clock divider 216 may reduce the frequency of the first clock 220 and output a second clock 222. The clock multiplexer 218 outputs the information timer 210 from a selection of the reference timer 208, the first clock 220, and the second clock 222. The clock multiplexer 218 may be optional in the timing generator 202. The second clock 222 may output from the timing generator 202 for the information timer 210.

For example, the reference timer 208 may be a clock signal in the kilohertz (kHz) or megahertz (MHz) range and the clock generator 214 may generate the first clock 220 in the gigahertz (GHz) range, such as 1 GHz, based on the reference timer 208. The clock generator 214 may form a relationship, such as a scalar multiple or a proportion, between the reference timer 208 and the first clock 220. The clock generator 214 may be programmable or fixed. The clock generator 214 may be formed in a number of different ways, such as a phase lock loop with programmable numerator and denominator values. Alternatively, the reference timer 208 may be optional. The clock generator 214 may output the first clock 220 without the reference timer 208.

The first clock 220 may toggle at a frequency sufficiently high to operate other modules in the timing generator 202 at a predetermined performance but the frequency may be too high to be used by the information generator 204. The clock divider 216 may form a relationship, such as a division or a proportion, between the first clock 220 and the second clock 222.

For example, if the first clock 220 is 1 GHz, the clock divider 216 may output the second clock 222 at 100 MHz. The clock divider 216 may be implemented in a number of different ways, such as digital logic or analog circuit. The digital logic may include counters and count compares to output the second clock 222 from the first clock 220. The analog circuit may be tap points in the clock generator 214. The clock divider 216 may be fixed or programmable.

The information generator 204 receives the information timer 210 from the timing generator 202 and outputs the system information 212. The information generator 204 includes a capture module 224, an accumulation module 226, and a system information storage 228. The capture module 224 receives the information timer 210 and outputs an increment signal 230. The accumulation module 226 receives the increment signal 230, increments an intermediate information 232 from the system information storage 228, and outputs an updated system information 234. The intermediate information 232 represents the system information 212 being processed by the information generator 204. The system information storage 228 stores the updated system information 234 for further processing and outputs the system information 212.

The capture module 224 may be implemented in a number of different ways. The capture module 224 may include a counter (not shown) that may be incremented by the information timer 210. The capture module 224 may also include a comparison (not shown) to a predetermined value, such as a full count value, for outputting the increment signal 230. The capture module 224 may include a synchronization module (not shown) for capturing the information timer 210. For example, if the information timer 210 may be a 100 MHz signal, the capture module 224 may include a 32-bit counter such that the increment signal 230 may activate once every minute.

The accumulation module 226 may be implemented in a number of different ways. The accumulation module 226 increments the intermediate information 232 based on the increment signal 230 and outputs the updated system information 234. The accumulation module 226 may include an adder (not shown). The accumulation module 226 and the system information storage 228 may be implemented in a single functional structure, such as a counter or a finite state machine.

The information generator 204 may output the system information 212 in a number of different formats. For example, the information generator 204 may output the system information 212 as a binary count or count values having different fields representing years, months, days, hours, and seconds. The translation of the system information 212 to a predetermined format may be performed by the system information storage 228.

The non-volatile storage 206 receives and stores the system information 212 for further processing. The non-volatile storage 206 retains the system information 212 after power down of the electronic systems 100 having the run-time system 200. For example, if the accumulation module 226 increments every minute, the non-volatile storage 206 may have six bytes for the system information 212 to represent a maximum system run-time of five years. The non-volatile storage 206 may include a memory hierarchy including a volatile memory 236, a first non-volatile memory 238, and a second non-volatile memory 240.

The volatile memory 236 may be implemented in a number of different ways, such as a static random access memory (SRAM) or a dynamic random access memory (DRAM). The volatile memory 236 may provide real-time, periodic, or aperiodic storage of the system information 212 without affecting endurance cycles found in some non-volatile memory architectures. The volatile memory 236 may output the system information 212 or a first level information 242. The volatile memory 236 is optional in the non-volatile storage 206.

The first non-volatile memory 238 may receive the system information 212, the first level information 242 from the volatile memory 236, or both. The first non-volatile memory 238 may be implemented in a number of different ways, such as a Flash memory. The first non-volatile memory 238 may output the system information 212, a second level information 244, or both.

The second non-volatile memory 240 may receive the system information 212, the second level information 244, or both. The second non-volatile memory 240 may also receive the first level information 242 from the volatile memory 236. The second non-volatile memory 240 may be implemented in a number of different ways, such as a hard disk drive. The second non-volatile memory 240 may output the system information 212.

For illustrative purposes, the run-time system 200 describes the flow of information from the timing generator 202 to the information generator 204 to the non-volatile storage 206, although it is understood that the information flow may in different directions. For example, the information flow may be from the non-volatile storage 206 to the information generator 204 and the timing generator 202. Alternatively, the information flow may also be from the information generator 204 to the timing generator 202.

Also for illustrative purposes, the functional flow within the timing generator 202, the information generator 204, and the non-volatile storage 206 are described in a simplex fashion, although it is understood that the functional flow within the timing generator 202, the capture module 224, and the non-volatile storage 206 may not be simplex. For example, the second non-volatile memory 240 may output the system information 212 to the first non-volatile memory 238 or the volatile memory 236. Also, the first non-volatile memory 238 may output the system information 212 to the volatile memory 236.

Further for illustrative purposes, the capture module 224 is described as translating the system information 212 into predetermined formats, although it is understood that the translation may occur in other modules. For example, the timing generator 202 or a system operating system (not shown) may translate the system information 212 to the predetermined formats.

Yet further for illustrative purposes, the run-time system 200 is described with the timing generator 202, the capture module 224, and the non-volatile storage 206, although it is understood that the partition of the run-time system 200 may be different. For example, the timing generator 202 and the capture module 224 may be in a single functional module. Alternatively, portions of the timing generator 202, the capture module 224, and the non-volatile storage 206 may be in the other modules. Other functional modules (not shown), such as diagnostics modules, may also be included in the run-time system 200.

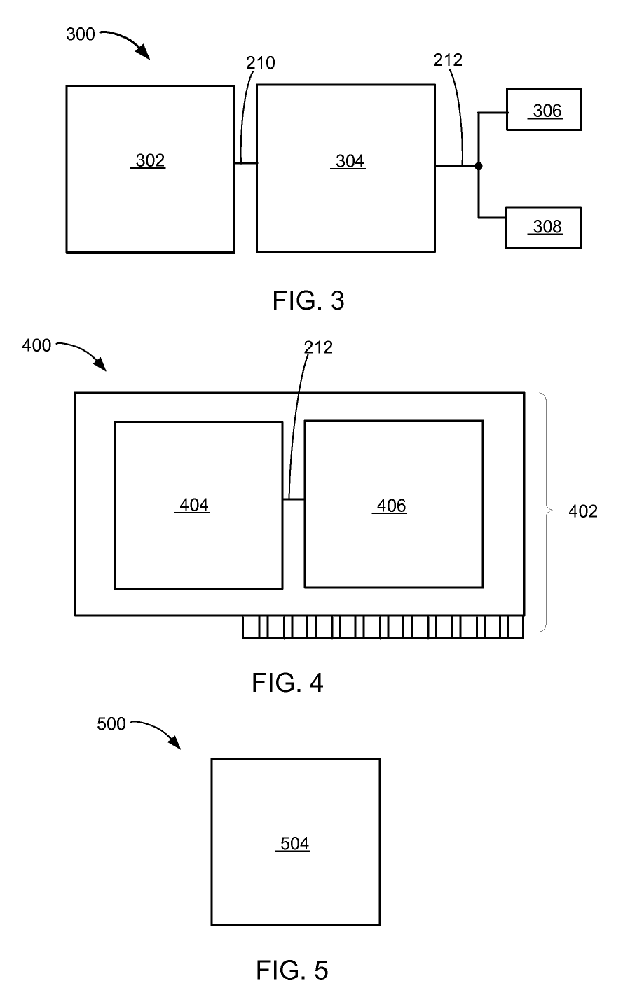

Referring now to FIG. 3, therein is shown a schematic view of a run-time system 300 in an embodiment of the present invention. The run-time system 300 may be included as part of a printed circuit board (not shown) or an electronic assembly (not shown) of the electronic systems 100 of FIG. 1 for providing information, such as run-time or power-on time by a customer or in the factory. The schematic diagram of the run-time system 300 may represent an implementation of the run-time system 200 of FIG. 2.

The schematic diagram depicts a computing device 302, a run-time integrated circuit device 304, a first memory 306, and a second memory 308. The computing device 302 may be a processor or a microcontroller. The run-time integrated circuit device 304 may be in integrated circuit device. The first memory 306 may be a volatile random access memory, such as a static random access memory or dynamic random access memory. The second memory 308 may be a non-volatile random access memory, such as a Flash memory.

The computing device 302 may output the information timer 210 and may include functions of the timing generator 202 of FIG. 2. The run-time integrated circuit device 304 may include functions of the information generator 204 of FIG. 2 and may output the system information 212 based on the information timer 210. The first memory 306 and the second memory 308 may be part of the non-volatile storage 206 of FIG. 2 for storing and providing the system information 212.

The system information 212 may be stored in the first memory 306, the second memory 308, or both. The first memory 306 and the second memory 308 may provide a memory hierarchy in the run-time system 300. The first memory 306 may provide access performance and frequency without concerns for endurance cycles found in non-volatile random access memory architectures, such as Flash memories. The second memory 308 retains the system information 212 with the run-time system 300 powered down. The computing device 302, the run-time integrated circuit device 304, the first memory 306, or a combination thereof may retrieve the system information 212 from the second memory 308 during power up sequence.

Referring now to FIG. 4, therein is shown a schematic view of a run-time system 400 in an alternative embodiment of the present invention. The schematic view depicts the run-time system 400 including a run-time integrated circuit device 404 and a non-volatile memory 406 mounted on a subsystem card 402, such as a plug-in card. The run-time system 400 may be plugged in the electronic systems 100 of FIG. 1 for providing information, such as run-time or power-on time by the customer or in the factory. The schematic diagram of the run-time system 400 may represent an implementation of the run-time system 200 of FIG. 2.

The run-time integrated circuit device 404 may be an integrated circuit device outputting the system information 212. The run-time integrated circuit device 404 may include functions of the timing generator 202 of FIG. 2 and the information generator 204 of FIG. 2. The non-volatile memory 406 may be represent the non-volatile storage 206 of FIG. 2.

For illustrative purposes, the run-time integrated circuit device 404 is described including functions of the timing generator 202 and the information generator 204, although it is understood that the run-time integrated circuit device 404 may include other functions, such as a general purposes computing module. Also for illustrative purposes, the non-volatile memory 406 is described as the non-volatile storage 206 for the system information 212 in the run-time system 400, although it is understood that the non-volatile memory 406 may be part of a memory hierarchy in the electronic systems 100 having the run-time system 400.

Referring now to FIG. 5, therein is shown a schematic view of a run-time system 500 in another alternative embodiment of the present invention. The run-time system 500 includes a run-time integrated circuit device 504, such as a system on a chip (SOC). The run-time system 500 may be included as part of a printed circuit board (not shown) or an electronic assembly (not shown) of the electronic systems 100 of FIG. 1 for providing information, such as run-time or power-on time by a customer or in the factory. The schematic diagram of the run-time system 500 may represent an implementation of the run-time system 200 of FIG. 2.

The run-time integrated circuit device 504 includes the functions of the timing generator 202 of FIG. 2, the information generator 204 of FIG. 2, and the non-volatile storage 206 of FIG. 2, such as the volatile memory 236 of FIG. 2 or the first non-volatile memory 238 of FIG. 2. For illustrative purposes, the run-time integrated circuit device 504 is described as having functions of the timing generator 202, the information generator 204, and the non-volatile storage 206, although it is understood that the run-time integrated circuit device 504 may have different functions, such as a general-purpose computing module.

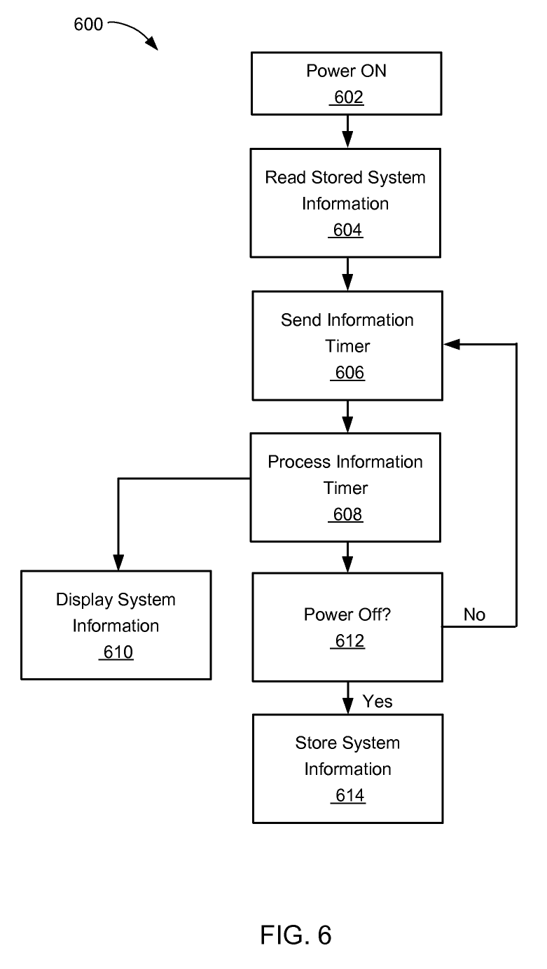

Referring now to FIG. 6, therein is shown a flow chart of a run-time system 600 for operation the run-time system 300 of FIG. 3 in an embodiment of the present invention. The run-time system 600 includes powering the run-time system 300 in a block 602; reading the system information from the second memory 308 by the run-time integrated circuit device 304 in a block 604; sending the information timer 210 from the computing device 302 to the run-time integrated circuit device 304 in a block 606; processing the information timer 210 with the run-time integrated circuit device 304 for generating the system information 212 including counting the information timer 210, incrementing the system information 212 based on the counting in a block 608; formatting the system information 212 with the run-time integrated circuit device 304 for displaying in a block 610; checking the power status of the run-time system 300 in a block 612; and writing the system information 212 in the second memory 308 with power off sequence of the run-time system 300 in a block 614.

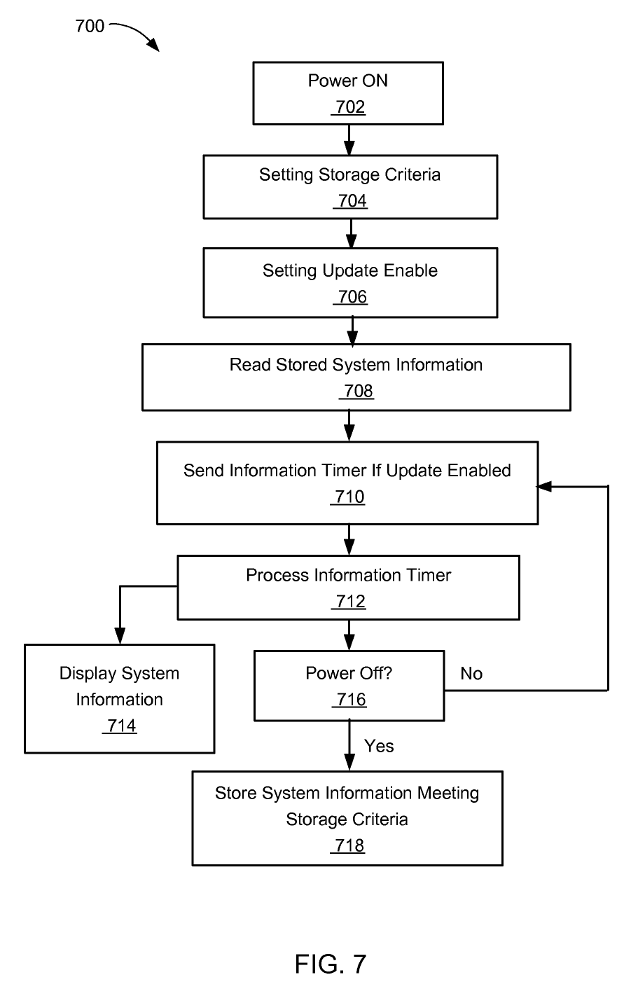

Referring now to FIG. 7, therein is shown a flow chart of a run-time system 700 for operation the run-time system 300 of FIG. 3 in an alternative embodiment of the present invention. The run-time system 700 includes powering the run-time system 300 in a block 702; setting a storage criteria for storing the system information 212 to the second memory 308 in a block 704; setting an update enable for the system information 212 in a block 706; reading the system information 212 from the second memory 308 by the run-time integrated circuit device 304 in a block 708; sending the information timer 210 from the computing device 302 to the run-time integrated circuit device 304 based on the update enable in a block 710; processing the information timer 210 with the run-time integrated circuit device 304 for generating the system information 212 including counting the information timer 210, incrementing the system information 212 based on the counting in a block 712; formatting the system information 212 with the run-time integrated circuit device 304 for displaying in a block 714; checking the power status of the run-time system 300 in a block 716; and writing the system information 212 in the second memory 308 by meeting the storage criteria or with a power off sequence the run-time system 300 in a block 718.

For illustrative purposes, the run-time system 700 depicts setting the storage criteria and the update enable, although it is understood that the run-time system 700 may have other programmable settings, such as diagnostics mode, factory mode, or idle mode with power on. Also for illustrative purposes, the run-time system 700 is described with the run-time system 300, although it is understood that the run-time system 700 may be operated with other implementations, such as the run-time system 400 of FIG. 4 or the run-time system 500 of FIG. 5.

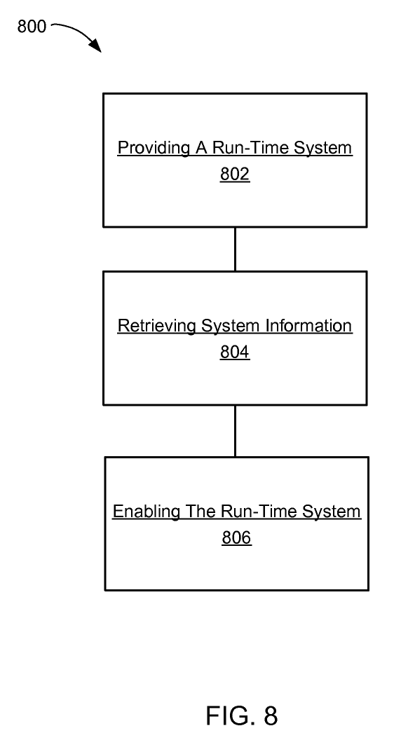

Referring now to FIG. 8, therein is shown a flow chart of an electronic system 800 for operation of the electronic systems 100 in an embodiment of the present invention. The system 800 includes providing a run-time system having a timing generator, an information generator, and a non-volatile storage in a block 802; retrieving a system information from the non-volatile storage in a block 804; and enabling the run-time system including generating an information timer, updating the system information based on the information timer for generating an updated system information, and storing the updated system information in the non-volatile storage in a block 806.

Yet other important aspects of the embodiments include that it valuably supports and services the historical trend of reducing costs, simplifying systems, and increasing performance.

These and other valuable aspects of the embodiments consequently further the state of the technology to at least the next level.

Thus, it has been discovered that the electronic system of the present invention furnishes important and heretofore unknown and unavailable solutions, capabilities, and functional aspects for improving reliability in systems. The resulting processes and configurations are straightforward, cost-effective, uncomplicated, highly versatile, and effective, can be implemented by adapting known technologies, and are thus readily suited for efficiently and economically manufacturing stackable integrated circuit package system.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. An electronic system comprising:
providing a run-time system having a timing generator, an information generator, and a non-volatile storage;
retrieving a system information from the non-volatile storage; and
enabling the run-time system including:
generating an information timer,
updating the system information based on the information timer for generating an updated system information, and
storing the updated system information in the non-volatile storage.

2. The system as claimed in claim 1 wherein retrieving the system information from the non-volatile storage includes operating the information generator for retrieving the system information.

3. The system as claimed in claim 1 wherein updating the system information based on the information timer for generating the updated system information includes operating the information generator for incrementing the system information.

4. The system as claimed in claim 1 wherein updating the system information based on the information timer for generating the updated system information includes operating the information generator for outputting the updated system information.

5. The system as claimed in claim 1 wherein storing the updated system information in the non-volatile storage includes storing the updated system information from the information generator.

6. An electronic system comprising:
providing a run-time system including:
providing a timing generator for generating an information timer,
providing an information generator for generating an updated system information, and
providing a non-volatile storage for storing the updated system information;
retrieving a system information from the non-volatile storage; and
enabling the run-time system including:
operating the timing generator for outputting the information timer,
incrementing the system information by the information generator based on the information timer for generating an updated system information, and
storing the updated system information in the non-volatile storage.

7. The system as claimed in claim 6 wherein enabling the run-time system includes powering the run-time system.

8. The system as claimed in claim 6 wherein retrieving the system information includes retrieving run-time information of the electronic system.

9. The system as claimed in claim 6 wherein:
providing the timing generator for generating the information timer includes:
providing a processor having the timing generator;
providing the information generator for generating the updated system information also includes:
providing a run-time integrated circuit device having the information generator; and
providing the non-volatile storage for storing the updated system information further includes:
providing a non-volatile random access memory.

10. The system as claimed in claim 6 wherein providing the run-time system includes providing a subsystem card with a run-time integrated circuit device thereon.

11. An electronic system comprising:
a run-time system including:
a timing generator for generating an information timer,
an information generator, coupled with the timing generator, for generating a system information based on the information timer, and
a non-volatile storage, coupled with the information generator, for storing the system information.

12. The system as claimed in claim 11 wherein the timing generator includes a clock divider for generating the information timer.

13. The system as claimed in claim 11 wherein the information generator includes an accumulation module for generating an updated system information based on the system information.

14. The system as claimed in claim 11 wherein the timing generator includes a clock generator.

15. The system as claimed in claim 11 wherein the run-time system includes a run-time integrated circuit device.

16. The system as claimed in claim 11 wherein:
the run-time system including:
the timing generator has a clock divider for generating the information timer,
the information generator, coupled with the timing generator, has an accumulation module for generating the system information based on the information timer, and
the non-volatile storage, coupled with the information generator, has non-volatile memory for storing the system information.

17. The system as claimed in claim 16 wherein:
the timing generator includes:
a processor having the timing generator;
the information generator also includes:
a run-time integrated circuit device having the information generator; and
the non-volatile storage further includes:
a non-volatile random access memory.

18. The system as claimed in claim 16 wherein the run-time system includes a subsystem card with a run-time integrated circuit device thereon.

19. The system as claimed in claim 16 wherein the run-time system includes a run-time integrated circuit device having the non-volatile storage.

20. The system as claimed in claim 16 wherein the information generator includes a capture module.
